(19) United States
(12) Patent Application Publication
(10) Pub. No.: US 2025/0309795 A1
(43) Pub. Date: Oct. 2, 2025

(54) MOTOR DEVICE, WIPER DEVICE, AND MOTOR CONTROL METHOD

(71) Applicant: MITSUBA Corporation, Gunma (JP)

(72) Inventors: RYO OHORI, Gunma (JP); TAKESHI KANAI, Gunma (JP); ATSUSHI MOCHIDA, Gunma (JP)

(73) Assignee: MITSUBA Corporation, Gunma (JP)

(21) Appl. No.: 19/084,684

(22) Filed: Mar. 19, 2025

(30) Foreign Application Priority Data
Apr. 1, 2024 (JP) 2024-058980

(51) Int. Cl. H02P 6/08; B60S 1/08

(52) U.S. Cl. CPC H02P 6/085; B60S 1/08

(57) ABSTRACT

A motor device is provided that includes a motor, a drive signal generation portion configured to control a duty ratio indicating a drive output of the motor so as not to exceed a duty ratio upper limit value and generates a drive signal in accordance with the duty ratio, an inverter configured to output an output signal to rotationally drive the motor, a rotation speed detection portion configured to detect a rotation speed of the motor, an acceleration detection portion configured to detect whether the motor is accelerating or not, and an upper limit value setting portion configured to change the duty ratio upper limit value when a rotation speed of the motor exceeds a first threshold value and the motor is rotating under acceleration. The upper limit value setting portion sets the first upper limit value to gradually increase in accordance with an increase in the rotation speed.

### CROSS-REFERENCE TO RELATED APPLICATION

This application claims the priority benefits of Japanese application no. 2024-058980, filed on Apr. 1, 2024. The entirety of the above-mentioned patent application is hereby incorporated by reference herein and made a part of this specification.

### BACKGROUND

### Technical Field

The disclosure relates to a motor device, a wiper device, and a motor control method.

### Description of Related Art

In motor devices used in vehicle wiper devices and the like, there are cases where a sudden load is applied during motor driving, and when the rotation speed of the motor decreases, a phenomenon occurs where the duty (duty ratio) cannot be increased, resulting in the motor stopping. To prevent such a phenomenon, in recent years, motor devices are known that prevent motor stoppage by changing the duty upper limit value (duty ratio upper limit value) to a higher value when accelerating (for example, see Patent Document 1 (Japanese Patent Application Laid-Open Publication No. 2023-62836)).

However, in conventional motor devices as described above, for example, when the rotation speed of the motor is low, to prevent excessive current flow due to raising the duty too high, changing the duty ratio upper limit value to a higher value is prohibited when the rotation speed is equal to or less than a predetermined threshold value. Thus, in conventional motor devices, for example, when a load is applied from motor startup, the motor may stall because the duty cannot be increased due to the low duty ratio upper limit value.

The disclosure provides a motor device, a wiper device, and a motor control method that may suppress motor stalling even when a load is applied at motor startup.

### SUMMARY

One aspect of the disclosure is a motor device, including: a motor that is rotationally driven; a drive signal generation portion configured to control a duty ratio indicating a drive output of the motor so as not to exceed a duty ratio upper limit value and generates a drive signal in accordance with the duty ratio; an inverter configured to output an output signal to rotationally drive the motor based on the drive signal; a rotation speed detection portion configured to detect a rotation speed of the motor; an acceleration detection portion configured to detect whether the motor is accelerating or not; and an upper limit value setting portion, configured to execute change processing to change the duty ratio upper limit value to a second upper limit value higher than a first upper limit value that is preset when a rotation speed of the motor exceeds a first threshold value and the motor is rotating under acceleration. The upper limit value setting portion sets the first upper limit value to gradually increase in accordance with an increase in the rotation speed while the rotation speed is within a range from a second threshold value, that is lower than the first threshold value, to the first threshold value.

Further, one aspect of the disclosure is a motor control method for controlling a motor that is rotationally driven by an output signal output by an inverter based on a drive signal. The motor control method includes: a drive signal generation step in which a drive signal generation portion is configured to control a duty ratio indicating a drive output of the motor so as not to exceed a duty ratio upper limit value and generates the drive signal in accordance with the duty ratio; a rotation speed detection step in which a rotation speed detection portion is configured to detect a rotation speed of the motor; an acceleration detection step in which an acceleration detection portion is configured to detect whether the motor is accelerating or not; and an upper limit value setting step in which an upper limit value setting portion is configured to execute change processing to change the duty ratio upper limit value to a second upper limit value higher than a first upper limit value that is preset when a rotation speed of the motor exceeds a first threshold value and the motor is rotating under acceleration. In the upper limit value setting step, the upper limit value setting portion sets the first upper limit value to gradually increase in accordance with an increase in the rotation speed while the rotation speed is within a range from a second threshold value, that is lower than the first threshold value, to the first threshold value.

### BRIEF DESCRIPTION OF THE DRAWINGS

FIG. 1 is a block diagram showing an example of a motor device according to the first embodiment.

FIG. 2 is a flowchart showing an example of duty limit value switching processing of the motor device according to the first embodiment.

FIG. 3 is a diagram illustrating an example of duty limit value switching processing of the motor device according to the first embodiment.

FIG. 4 is a flowchart showing an example of energization control processing of the motor device according to the first embodiment.

FIG. 5 is a diagram illustrating an example of energization control processing of the motor device according to the first embodiment.

FIGS. 6A and 6B are diagrams illustrating an example of effects of the motor device according to the first embodiment.

FIG. 7 is a diagram illustrating a modification example of duty limit value switching processing of the motor device according to the first embodiment.

FIG. 8 is a configuration diagram showing an example of a wiper device according to the second embodiment.

### DESCRIPTION OF THE EMBODIMENTS

Hereinafter, a motor device, a wiper device, and a motor control method according to an embodiment of the disclosure are described with reference to the drawings.

According to the disclosure, it is possible to suppress motor stalling even when a load is applied at motor startup.

### First Embodiment

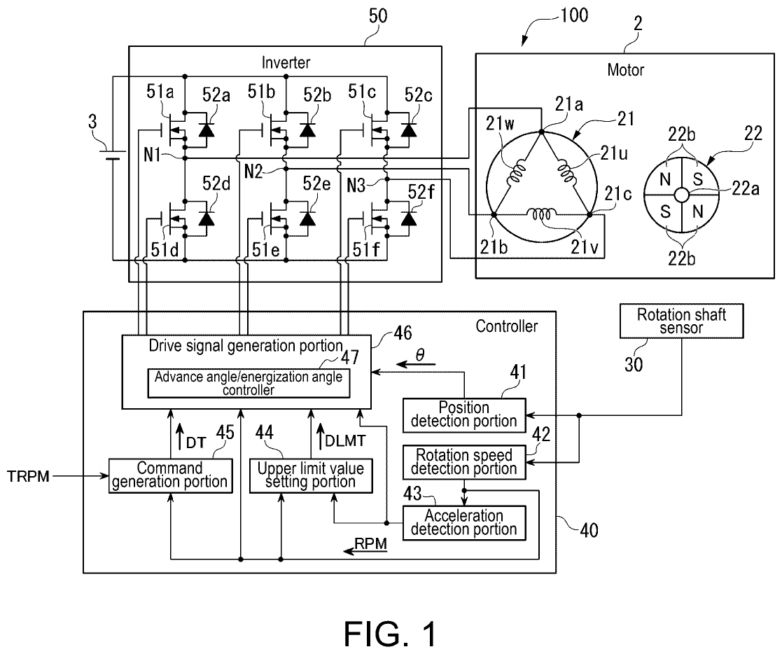

FIG. 1 is a block diagram showing an example of a motor device 100 according to the first embodiment.

As shown in FIG. 1, the motor device 100 includes a motor 2, a rotation shaft sensor 30, a controller 40, and an inverter 50.

The motor device 100 according to this embodiment is used, for example, in a wiper device that wipes a window glass of a vehicle.

The motor 2 is, for example, a three-phase four-pole brushless motor. The motor 2 is rotationally driven by an output signal output from the inverter 50 based on a drive signal described later.

Further, the motor 2 also includes a stator 21 and a rotor 22.

The stator 21 is fixed to the inner circumference of the case of the motor 2. The stator 21 includes three-phase armature coils (21u, 21v, 21w). The stator 21 has the armature coils (21u, 21v, 21w) wound thereon. For example, the three-phase armature coils (21u, 21v, 21w) are connected by delta connection.

In the delta connection, the armature coil 21u and the armature coil 21w are connected by a connection point 21a, the armature coil 21v and the armature coil 21w are connected by a connection point 21b, and the armature coil 21u and the armature coil 21v are connected by a connection point 21c.

The rotor 22 is provided inside the stator 21. The rotor 22 includes, for example, a rotor shaft 22a and a four-pole permanent magnet 22b attached to the rotor shaft 22a. Multiple bearings (not shown) are provided inside the case of the motor 2, and the rotor shaft 22a is rotatably supported by the multiple bearings.

The rotation shaft sensor 30 detects a signal corresponding to the rotation of the rotor 22. The rotation shaft sensor 30 includes, for example, three Hall ICs (not shown). These three Hall ICs output pulse signals that are phase-shifted by 120 degrees from each other to the controller 40 in response to the rotation of the rotor 22. That is, the rotation shaft sensor 30 generates pulse signals based on the change in magnetic poles of a sensor magnet (not shown) placed on the rotor shaft 22a accompanying the rotation of the rotor 22, and outputs them to the controller 40. Each Hall IC detects a position shifted by 120 degrees in electrical angle from each other.

The controller 40 is a processor including, for example, a CPU (central processing unit), and comprehensively controls the motor device 100. The controller 40 performs PWM (pulse width modulation) control, sets a duty ratio corresponding to the target rotational output of the rotor 22 (for example, target rotation speed TRPM), and outputs drive signals according to the set duty ratio to the inverter 50. Further, the controller 40 controls the driving of the motor 2 through the inverter 50 by, for example, rectangular wave energization.

Further, the controller 40 also includes a position detection portion 41, a rotation speed detection portion 42, an acceleration detection portion 43, an upper limit value setting portion 44, a command generation portion 45, and a drive signal generation portion 46.

The position detection portion 41 detects the rotational position (θ) of the rotor 22 based on the pulse signals supplied from the rotation shaft sensor 30. The position detection portion 41 outputs the detected rotational position of the rotor 22 to the drive signal generation portion 46 described later.

The rotation speed detection portion 42 detects, for example, the rotation speed (RPM) of the motor 2 (rotor 22) based on the pulse signals supplied from the rotation shaft sensor 30, and outputs the detected rotation speed of the motor 2 (rotor 22) to the acceleration detection portion 43, the upper limit value setting portion 44, and the command generation portion 45 described later.

It is noted that in this description, “rotation speed” refers to “speed of rotation” indicating the number of rotations per unit time.

The acceleration detection portion 43 detects whether the rotation of the motor 2 is rotating under acceleration or not. The acceleration detection portion 43 detects, for example, that the motor 2 is accelerating in the case where the rotation speed detected at predetermined time intervals by the rotation speed detection portion 42 increases continuously for a predetermined number of times. The acceleration detection portion 43 outputs the detection result of whether the motor 2 is accelerating or not to the upper limit value setting portion 44.

The upper limit value setting portion 44 sets a duty limit value (duty ratio upper limit value) which is an upper limit value of the duty ratio (also called output duty) indicating the drive output of the motor 2. The duty limit value includes a normal duty limit value (first upper limit value) that is set in advance and a corrected duty limit value (second upper limit value) used during acceleration of the motor 2, and the upper limit value setting portion 44 switches between and outputs the normal duty limit value (first upper limit value) and the corrected duty limit value (second upper limit value).

The normal duty limit value is a limit value used during normal operation other than during acceleration. The upper limit value setting portion 44 changes and sets the normal duty limit value in accordance with the rotation speed of the motor 2 (hereinafter, may be referred to as motor rotation speed). The upper limit value setting portion 44, for example, changes the normal duty limit value to a higher value as the rotation speed becomes higher, and changes the normal duty limit value to a lower value as the rotation speed becomes lower. Specifically, the upper limit value setting portion 44 changes the normal duty limit value in accordance with the motor rotation speed as shown in FIG. 3 described later.

The upper limit value setting portion 44 executes change processing to change the duty limit value to a corrected duty limit value higher than the normal duty limit value that is preset, in the case where the motor rotation speed exceeds a rotation speed RPM1 (first threshold value) and the motor 2 is rotating under acceleration.

That is, the upper limit value setting portion 44 outputs the corrected duty limit value (LMT2) as the duty limit value (LMT) to the drive signal generation portion 46 in the case where the motor rotation speed exceeds the rotation speed RPM1 and the motor 2 is accelerating. Further, the upper limit value setting portion 44 outputs the normal duty limit value (LMT1) as the duty limit value (LMT) to the drive signal generation portion 46 in the case where the motor 2 is not accelerating (in the case of decelerating or constant speed driving).

Further, the upper limit value setting portion 44 sets the normal duty limit value to gradually increase in accordance with the increase in the rotation speed while the motor rotation speed is within a range from a rotation speed RPM2 (second threshold value), that is lower than the rotation speed RPM1, to the rotation speed RPM1.

Further, the normal duty limit value (first upper limit value) is set to a set minimum value, which is a constant value, in the case where the rotation speed is less than the rotation speed RPM2. That is, the upper limit value setting portion 44 sets the normal duty limit value to the set minimum value, which is a constant value, in the case where the rotation speed is less than the rotation speed RPM2. Further, the upper limit value setting portion 44, when the motor 2 starts, gradually increases the normal duty limit value, starting from the set minimum value, in accordance with an increase in the rotation speed within a range from the rotation speed RPM2 to the rotation speed RPM1.

It is noted that the upper limit value setting portion 44, for example, sets the corrected duty limit value by adding a correction amount (α) to the normal duty limit value as shown in the following equation c(1). Here, α is a predetermined fixed value.

$$Corrected duty limit value = Normal duty limit value + α \qquad ( 1 )$$

It is noted that in the case of generating the correction amount to the normal duty limit value by equation (1), when the normal duty limit value is changed in accordance with the rotation speed of the motor 2, the corrected duty limit value is also changed in accordance with the rotation speed of the motor 2. That is, the upper limit value setting portion 44 changes the corrected duty limit value in accordance with the rotation speed of the motor 2.

Further, in the above equation (1), the corrected duty limit value is set by adding a fixed value correction amount (α) to the normal duty limit value, but the corrected duty limit value may be set by multiplying the normal duty limit value by a predetermined constant multiple (β times) as shown in the following equation (2). That is, in the change processing, the upper limit value setting portion 44 may change the normal duty limit value to a corrected duty limit value obtained by multiplying the normal duty limit value by a predetermined constant multiple (β times). Here, β is a predetermined fixed value of “1.0” or more.

$$Corrected duty limit value = Normal duty limit value \times β \qquad ( 2 )$$

Further, the upper limit value setting portion 44 invalidates the change processing that changes from the normal duty limit value to the corrected duty limit value in the case where the rotation speed of the motor 2 is equal to or less than the rotation speed RPM1 (first threshold value). That is, the upper limit value setting portion 44 performs control to output the normal duty limit value without using the corrected duty limit value even during acceleration in the case where the rotation speed of the motor 2 is low.

The command generation portion 45 generates an output command value (command value of PWM control) corresponding to a target rotational output (for example, target rotation speed TRPM) of the motor 2. The command generation portion 45, for example, generates a duty ratio, which is a command value of PWM control, in accordance with the current rotation speed (RPM) of the motor 2 acquired from the position detection portion 41 and the target rotation speed TRPM, and outputs the generated output command value as an output command value (DT) to the drive signal generation portion 46.

The drive signal generation portion 46 generates a drive signal so that a voltage of an energization waveform based on a sine wave is applied to the three-phase armature coils (21u, 21v, 21w) at an energization timing corresponding to the rotational position of the rotor 22, based on the output command value (DT) output by the command generation portion 45. The drive signal generation portion 46, for example, generates three-phase energization timing signals based on the rotational position (θ), generates drive signals (three-phase drive signals) that drive (conduct/non-conduct) the switching elements (51a to 51f) of the inverter 50 to be described later by PWM control based on the output command value (DT), and outputs the generated drive signals (three-phase drive signals) to the inverter 50.

Further, in the case where the output command value (DT) is a duty ratio greater than the duty limit value (LMT) output from the upper limit value setting portion 44, the drive signal generation portion 46 generates drive signals (three-phase drive signals) by PWM control using the duty limit value (LMT) instead of the output command value (DT). In this way, the drive signal generation portion 46 controls the duty ratio indicating the drive output of the motor 2 so as not to exceed the duty limit value (LMT), and generates drive signals according to the duty ratio.

Further, the drive signal generation portion 46 executes different energization control in accordance with the motor rotation speed. The drive signal generation portion 46 includes an advance angle/energization angle controller 47 that controls an advance angle and an energization angle of the applied voltage to the motor 2.

The advance angle/energization angle controller 47 changes the energization angle to a value exceeding 120 degrees and increases the advance angle in the case where the duty ratio is less than the duty limit value. Further, the advance angle/energization angle controller 47 sets the energization angle to 120 degrees or less in the case where the duty ratio is equal to the duty limit value and the rotation speed becomes less than a rotation speed RPM3 (less than the third threshold value). Here, the rotation speed RPM3 (third threshold value) is set to be equal to or greater than the rotation speed RPM1.

The inverter 50 outputs an output signal that rotationally drives the motor 2 based on the drive signals generated by the drive signal generation portion 46. That is, the inverter 50 drives the switching elements (51a to 51f) based on the drive signals generated by the drive signal generation portion 46 to apply an applied voltage based on the energization waveform to the three-phase armature coils (21u, 21v, 21w).

It is noted that the inverter 50 generates the applied voltage using direct current power supplied from the battery 3.

The inverter 50 includes six switching elements 51a to 51f connected in a three-phase bridge and diodes 52a to 52f.

The switching elements 51a to 51f are, for example, N-channel MOSFETs (metal oxide semiconductor field effect transistors) and constitute a three-phase bridge circuit.

The switching element 51a and the switching element 51d are connected in series between the positive terminal and the negative terminal of the battery 3, constituting a U-phase bridge circuit. The switching element 51a has its drain terminal connected to the positive terminal of the battery 3, its source terminal connected to a node N1, and its gate terminal connected to the signal line of the upper side drive signal of the U-phase, respectively. Further, the switching element 51d has its drain terminal connected to the node N1, its source terminal connected to the negative terminal of the battery 3, and its gate terminal connected to the signal line of the lower side drive signal of the U-phase, respectively. Further, the node N1 is connected to the connection point 21a of the motor 2.

The switching element 51b and the switching element 51e are connected in series between the positive terminal and the negative terminal of the battery 3, constituting a V-phase bridge circuit. The switching element 51b has its drain terminal connected to the positive terminal of the battery 3, its source terminal connected to a node N2, and its gate terminal connected to the signal line of the upper side drive signal of the V-phase, respectively. Further, the switching element 51e has its drain terminal connected to the node N2, its source terminal connected to the negative terminal of the battery 3, and its gate terminal connected to the signal line of the lower side drive signal of the V-phase, respectively. Further, the node N2 is connected to the connection point 21b of the motor 2.

The switching element 51c and the switching element 51f are connected in series between the positive terminal and the negative terminal of the battery 3, constituting a W-phase bridge circuit. The switching element 51c has its drain terminal connected to the positive terminal of the battery 3, its source terminal connected to a node N3, and its gate terminal connected to the signal line of the upper side drive signal of the W-phase, respectively. Further, the switching element 51f has its drain terminal connected to the node N3, its source terminal connected to the negative terminal of the battery 3, and its gate terminal connected to the signal line of the lower side drive signal of the W-phase, respectively. Further, the node N3 is connected to the connection point 21c of the motor 2.

Further, the diode 52a has its anode terminal connected to the node N1 and its cathode terminal connected to the positive terminal of the battery 3, respectively. Further, the diode 52d has its anode terminal connected to the negative terminal of the battery 3 and its cathode terminal connected to the node N1, respectively.

Further, the diode 52b has its anode terminal connected to the node N2 and its cathode terminal connected to the positive terminal of the battery 3, respectively. Further, the diode 52e has its anode terminal connected to the negative terminal of the battery 3 and its cathode terminal connected to the node N2, respectively.

Further, the diode 52c has its anode terminal connected to the node N3 and its cathode terminal connected to the positive terminal of the battery 3, respectively. Further, the diode 52f has its anode terminal connected to the negative terminal of the battery 3 and its cathode terminal connected to the node N3, respectively.

The battery 3 is, for example, a direct current power source such as a lead-acid battery or a lithium-ion battery, and supplies power to drive the motor 2.

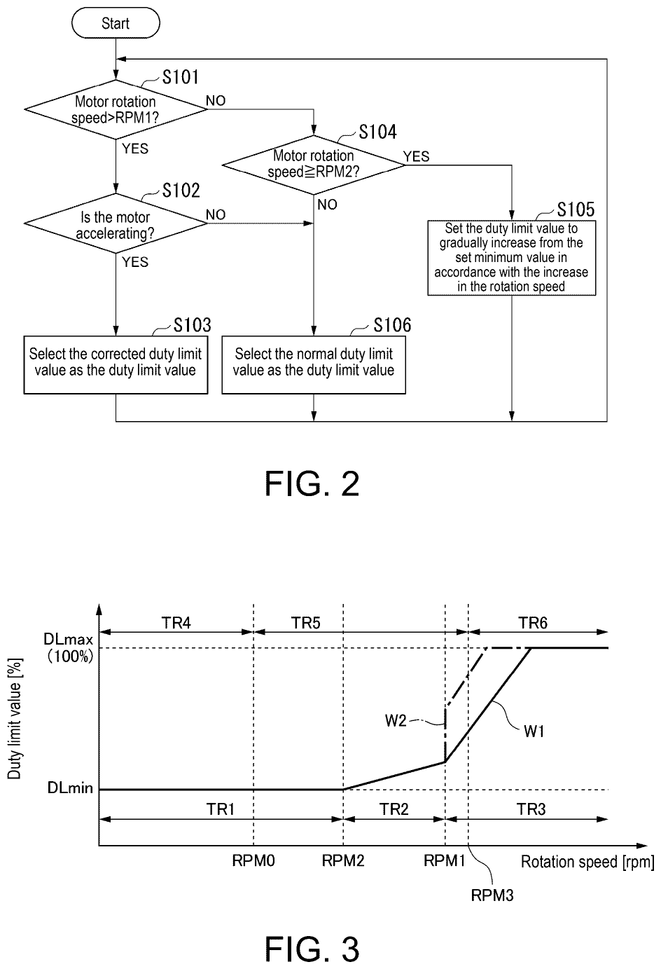

Next, with reference to the drawings, the operation of the motor device 100 according to this embodiment is described. FIG. 2 is a flowchart showing an example of duty limit value switching processing of the motor device 100 according to this embodiment. Here, the operation of the upper limit value setting portion 44 of the controller 40 is described.

As shown in FIG. 2, the upper limit value setting portion 44 first determines whether the motor rotation speed is greater than the rotation speed RPM1 (step S101). The upper limit value setting portion 44 acquires the motor rotation speed RPM detected by the rotation speed detection portion 42, and determines whether the motor rotation speed RPM is greater than the rotation speed RPM1 (or whether the motor rotation speed RPM is equal to or less than the rotation speed RPM1). The upper limit value setting portion 44 proceeds to step S102 in the case where the motor rotation speed RPM is greater than the rotation speed RPM1 (step S101: YES). Further, the upper limit value setting portion 44 proceeds to step S104 in the case where the motor rotation speed RPM is equal to or less than the rotation speed RPM1 (step S101: NO).

In step S102, the upper limit value setting portion 44 determines whether the motor 2 is accelerating. The upper limit value setting portion 44 determines, for example, whether the motor 2 is accelerating based on the detection result output by the acceleration detection portion 43. The upper limit value setting portion 44 proceeds to step S103 in the case where the motor 2 is accelerating (step S102: YES). Further, the upper limit value setting portion 44 proceeds to step S106 in the case where the motor 2 is not accelerating (step S102: NO).

In step S103, the upper limit value setting portion 44 selects the corrected duty limit value as the duty limit value. That is, the upper limit value setting portion 44 outputs the corrected duty limit value as the duty limit value (LMT) to the drive signal generation portion 46. After the processing of step S103, the upper limit value setting portion 44 returns the processing to step S101.

Further, in step S104, the upper limit value setting portion 44 determines whether the motor rotation speed is equal to or greater than the rotation speed RPM2. The upper limit value setting portion 44 acquires the motor rotation speed RPM detected by the rotation speed detection portion 42, and determines whether the motor rotation speed RPM is equal to or greater than the rotation speed RPM2. The upper limit value setting portion 44 proceeds to step S105 in the case where the motor rotation speed RPM is equal to or greater than the rotation speed RPM2 (step S104: YES). Further, the upper limit value setting portion 44 proceeds to step S106 in the case where the motor rotation speed RPM is less than the rotation speed RPM2 (step S104: NO).

In step S105, the upper limit value setting portion 44 sets the duty limit value to gradually increase from the set minimum value in accordance with the increase in the rotation speed. That is, the upper limit value setting portion 44 gradually increases the normal duty limit value, which is the duty limit value (LMT), starting from the set minimum value, in accordance with the increase in the rotation speed. After the processing of step S105, the upper limit value setting portion 44 returns the processing to step S101.

Further, in step S106, the upper limit value setting portion 44 selects the normal duty limit value as the duty limit value. That is, the upper limit value setting portion 44 outputs the normal duty limit value as the duty limit value (LMT) to the drive signal generation portion 46. After the processing of step S106, the upper limit value setting portion 44 returns the processing to step S101.

Next, with reference to FIG. 3, an example of the duty limit value switching processing of the motor device 100 according to this embodiment is described.

FIG. 3 is a diagram illustrating an example of the duty limit value switching processing of the motor device 100 according to this embodiment.

In FIG. 3, the horizontal axis of the graph represents the rotation speed [rpm] of the motor 2, and the vertical axis represents the duty limit value [%]. Further, the waveform W1 shows the waveform of the normal duty limit value, and the waveform W2 shows the waveform of the corrected duty limit value.

Further, in FIG. 3, the rotation speed RPM0 indicates the rotation speed at which the behavior of the motor 2 begins to stabilize. Further, the rotation speed RPM1 indicates the first threshold value described above, and the rotation speed RPM2 indicates the second threshold value. Further, the rotation speed RPM3 (third threshold value) indicates the rotation speed at which the behavior of the motor 2 stabilizes and wide-angle energization drive becomes possible. Further, the set minimum value DLmin indicates the minimum value in the setting of the duty limit value, and the set maximum value DLmax indicates the maximum value in the setting of the duty limit value.

In the period TR1 in FIG. 3 in which the rotation speed is less than the rotation speed RPM2, the upper limit value setting portion 44 sets the normal duty limit value to a fixed set minimum value DLmin as the duty limit value, as shown by the waveform W1.

Further, in the period TR2 where the rotation speed is from the rotation speed RPM2 to the rotation speed RPM1, the upper limit value setting portion 44 sets the normal duty limit value as the duty limit value to gradually increase in accordance with the increase in the rotation speed, starting from the set minimum value DLmin, as shown by the waveform W1. When the motor 2 starts and in the setting change processing, the normal duty limit value is increased, starting from the set minimum value DLmin, in proportion to (directly proportional to) the increase in the rotation speed within a range from the rotation speed RPM2 to the rotation speed RPM1 (period TR2).

As a result, the motor device 100 increases the normal duty limit value in proportion to the increase in the rotation speed, starting from the set minimum value DLmin, which is a constant value, so that a simple method may be used to appropriately control the duty limit value so that it is not exceeded when a load is applied from the time the motor is started.

Further, in the period TR3 where the rotation speed exceeds the rotation speed RPM1, the upper limit value setting portion 44, in the case where the motor 2 is not accelerating, sets the normal duty limit value as the duty limit value to further increase in accordance with the increase in the rotation speed, as shown by the waveform W1.

Further, in the period TR3 where the rotation speed exceeds the rotation speed RPM1, the upper limit value setting portion 44, in the case where the motor 2 is accelerating, sets the corrected duty limit value as the duty limit value, as shown by the waveform W2.

It is noted that in FIG. 3, the period TR4 indicates a period (or range of rotation speed) where the rotation speed is less than the rotation speed RPM0, and the period TR5 indicates a period (or range of rotation speed) from the rotation speed RPM0 to the rotation speed RPM3. Further, the period TR6 indicates a period (or range of rotation speed) where the rotation speed exceeds the rotation speed RPM3. The description of the periods TR4 to TR6 are provided in the description of the advance angle energization control to be described later.

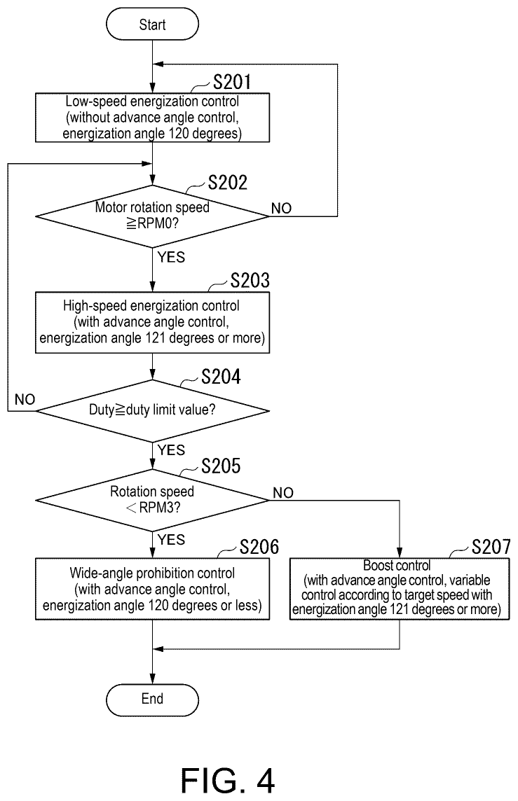

Next, with reference to FIG. 4, the energization control processing of the motor device 100 according to this embodiment is described.

FIG. 4 is a flowchart showing an example of energization control processing of the motor device 100 according to this embodiment.

As shown in FIG. 4, when the advance angle/energization angle controller 47 of the motor device 100 starts driving the motor 2, it first executes low-speed energization control (without advance angle control, energization angle 120 degrees) (step S201). Here, immediately after the start of driving the motor 2, since the behavior of the motor 2 is unstable, the advance angle/energization angle controller 47 prohibits advance angle energization.

Next, the advance angle/energization angle controller 47 determines whether the motor rotation speed is equal to or greater than the rotation speed RPM0 (step S202). The advance angle/energization angle controller 47 obtains the motor rotation speed (RPM) from the rotation speed detection portion 42, and determines whether the obtained rotation speed (RPM) is equal to or greater than the rotation speed RPM0. Here, as shown in FIG. 3 described above, the rotation speed RPM0 is a value less than the rotation speed RPM2 (RPM0<RPM2). The advance angle/energization angle controller 47 proceeds to step S203 in the case where the motor rotation speed is equal to or greater than the rotation speed RPM0 (step S202: YES). Further, the advance angle/energization angle controller 47 returns the processing to step S201 in the case where the motor rotation speed is less than the rotation speed RPM0 (step S202: NO).

In step S203, the advance angle/energization angle controller 47 executes high-speed energization control (with advance angle control, energization angle 121 degrees or more). The advance angle/energization angle controller 47, for example, performs control with advance angle control and with the energization angle fixed at a predetermined energization angle of 121 degrees or more.

Next, the advance angle/energization angle controller 47 determines whether the duty (output duty) is equal to or greater than the duty limit value (step S204). The advance angle/energization angle controller 47 obtains the output duty (output command value) generated by the command generation portion 45 and the duty limit value set by the upper limit value setting portion 44, and determines whether the output duty is equal to or greater than the duty limit value. The advance angle/energization angle controller 47 proceeds to step S205 in the case where the output duty is equal to or greater than the duty limit value (step S204: YES). Further, the advance angle/energization angle controller 47 returns the processing to step S202 in the case where the output duty is less than the duty limit value (step S204: NO).

In step S205, the advance angle/energization angle controller 47 determines whether the motor rotation speed is less than the rotation speed RPM3. The advance angle/energization angle controller 47 proceeds to step S206 in the case where the motor rotation speed is less than the rotation speed RPM3 (step S205: YES). Further, the advance angle/energization angle controller 47 proceeds to step S207 in the case where the motor rotation speed is equal to or greater than the rotation speed RPM3 (step S205: NO).

In step S206, the advance angle/energization angle controller 47 performs wide-angle prohibition control (with advance angle control, energization angle 120 degrees or less). In this case, the advance angle/energization angle controller 47, for example, performs control with advance angle control and with the energization angle fixed at a predetermined energization angle of 120 degrees or less (for example, 120 degrees). After the processing of step S206, the advance angle/energization angle controller 47 maintains the setting of the advance angle energization angle control and ends the processing.

Further, in step S207, the advance angle/energization angle controller 47 performs boost control (with advance angle control, variable control according to target speed with energization angle 121 degrees or more). The target speed here is the target rotation speed TRPM. After the processing of step S207, the advance angle/energization angle controller 47 maintains the setting of the boost control and ends the processing.

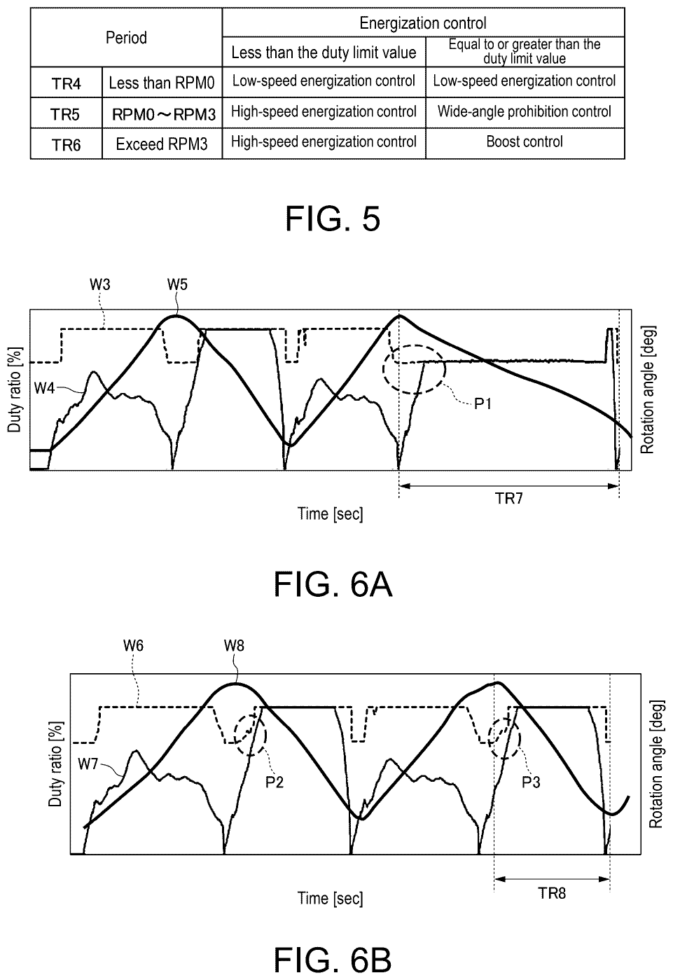

Next, with reference to FIG. 5, the energization control processing of the motor device 100 according to this embodiment is described.

FIG. 5 is a diagram illustrating an example of energization control processing of the motor device 100 according to this embodiment.

As shown in FIG. 5, in the period TR4 (period of less than the rotation speed RPM0 in FIG. 3), the advance angle/energization angle controller 47 performs low-speed energization control regardless of whether the output duty is less than the duty limit value.

Further, in the period TR5 (period of the rotation speed RPM0 to RPM3 in FIG. 3), the advance angle/energization angle controller 47 performs high-speed energization control and wide-angle energization in the case where the output duty is less than the duty limit value. Further, the advance angle/energization angle controller 47, in the period TR5, performs wide-angle prohibition control and prohibits wide-angle energization in the case where the output duty is equal to or greater than the duty limit value.

Further, in the period TR6 (period exceeding the rotation speed RPM3 in FIG. 3), the advance angle/energization angle controller 47 performs high-speed energization control in the case where the output duty is less than the duty limit value, and performs boost control in the case where the output duty is equal to or greater than the duty limit value. In this way, in the period TR6 exceeding the rotation speed RPM3, the advance angle/energization angle controller 47 always performs wide-angle energization control.

As described above, the motor device 100 according to this embodiment includes a motor 2 that is rotationally driven, a drive signal generation portion 46, a rotation speed detection portion 42, an inverter 50, a rotation speed detection portion 42, an acceleration detection portion 43, and an upper limit value setting portion 44. The drive signal generation portion 46 controls the duty ratio indicating the drive output of the motor 2 so as not to exceed the duty limit value (duty ratio upper limit value), and generates a drive signal in accordance with the duty ratio. The rotation speed detection portion 42 detects the rotation speed of the motor 2. The acceleration detection portion 43 detects whether the motor 2 is accelerating or not. The inverter 50 outputs an output signal that rotationally drives the motor 2 based on the drive signal. The upper limit value setting portion 44 executes change processing to change the duty ratio upper limit value to a second upper limit value (corrected duty limit value) higher than the first upper limit value (normal duty limit value) that is preset, in the case where the rotation speed of the motor 2 exceeds a first threshold value (rotation speed RPM1) and the motor 2 is rotating under acceleration. Then, the upper limit value setting portion 44 sets the first upper limit value (normal duty limit value) to gradually increase in accordance with the increase in the rotation speed while the rotation speed is within a range (period TR2) from a second threshold value (rotation speed RPM2), that is lower than the first threshold value (rotation speed RPM1), to the first threshold value (rotation speed RPM1).

Accordingly, the motor device 100 according to this embodiment sets the first upper limit value to gradually increase in accordance with the increase in the rotation speed within a range from the second threshold value (rotation speed RPM2) to the first threshold value (rotation speed RPM1), so that, for example, even in the case where a load is applied from the motor startup, stalling of the motor 2 may be suppressed. Further, the motor device 100 according to this embodiment prevents an overcurrent from flowing to the motor 2 due to excessive increase in the duty ratio by gradually increasing the first upper limit value. Thus, the motor device 100 according to this embodiment may achieve both stall suppression and protection of the motor 2 even at motor startup.

Here, with reference to FIGS. 6A and 6B, the effects of the motor device 100 according to this embodiment are described by comparing the operation of a conventional motor device with that of the motor device 100 according to this embodiment.

FIGS. 6A and 6B are diagrams illustrating an example of the effects of the motor device 100 according to this embodiment.

FIG. 6A is a diagram showing an example of the operation of a conventional motor device for comparison.

In FIG. 6A, the vertical axis of the graph represents duty ratio [%] or rotation angle [deg], and the horizontal axis represents time [sec]. Further, the example shown in FIG. 6A shows an example of a case where a conventional motor device is used for a vehicle wiper.

Further, in FIG. 6A, the waveform W3 shows the temporal change of the duty limit value of the conventional motor device, and the waveform W4 shows the temporal change of the duty ratio (output duty) of the conventional motor device. Further, the waveform W5 shows the temporal change of the rotation angle of the conventional motor device.

FIG. 6B is a diagram illustrating an example of the operation of the motor device 100 according to this embodiment.

In FIG. 6B, the vertical axis of the graph represents duty ratio [%] or rotation angle [deg], and the horizontal axis represents time [sec]. Further, the example shown in FIG. 6B shows an example of a case where the motor device 100 according to this embodiment is used for a vehicle wiper.

Further, in FIG. 6B, the waveform W6 shows the temporal change of the duty limit value of the motor device 100, and the waveform W7 shows the temporal change of the duty ratio (output duty) of the motor device 100. Further, the waveform W8 shows the temporal change of the rotation angle of the motor device 100.

In the conventional motor device, in the case where a high load occurs, as shown in the partial region P1 in FIG. 6A, the duty ratio (waveform W4) reaches the duty limit value (waveform W3), and the motor rotation speed decreases (stalls), requiring time (period TR7) for the wiper to complete its wiping operation (waveform W5).

In contrast, in the motor device 100 according to this embodiment, as shown in the partial region P2 and the partial region P3 in FIG. 6B, within a range from the second threshold value (rotation speed RPM2) to the first threshold value (rotation speed RPM1), the duty limit value is gradually increased, thereby suppressing the duty ratio (waveform W7) from reaching the duty limit value (waveform W6). Thus, in the motor device 100 according to this embodiment, even in the case where a high load occurs, as shown in the period TR8 in FIG. 6B, no time is required for the wiper to complete its wiping operation.

In this manner, the motor device 100 according to this embodiment may suppress stalling of the motor 2 even in the case where a load is applied from the start of the motor.

Further, in this embodiment, the first upper limit value is set to the set minimum value (DLmin), which is a constant value, in the case where the rotation speed is less than the second threshold value (less than the rotation speed RPM2). The upper limit value setting portion 44, when the motor 2 starts, gradually increases the first upper limit value, starting from the set minimum value (DLmin), in accordance with the increase in the rotation speed within a range from the second threshold value (rotation speed RPM2) to the first threshold value (rotation speed RPM1).

Accordingly, the motor device 100 according to this embodiment gradually increases the first upper limit value in accordance with the increase in the rotation speed, starting from the set minimum value (DLmin), which is a constant value, so that in the case where the rotation speed is less than the second threshold value (less than the rotation speed RPM2) and the behavior of the motor 2 is unstable, the duty ratio may be minimized to prevent overcurrent, thereby prioritizing the protection of the motor 2.

Further, in this embodiment, the drive signal generation portion 46 includes an advance angle/energization angle controller 47 that controls the advance angle and the energization angle of the applied voltage to the motor 2. The advance angle/energization angle controller 47, in the case where the duty ratio is less than the duty limit value, changes the energization angle to a value exceeding 120 degrees and increases the advance angle. Further, the advance angle/energization angle controller 47, in the case where the duty ratio is equal to the duty limit value, and the rotation speed becomes less than a third threshold value (less than the rotation speed RPM3) that is set to be equal to or greater than the first threshold value (rotation speed RPM1 or greater), sets the energization angle to 120 degrees or less.

Accordingly, the motor device 100 according to this embodiment, in the case where the duty ratio is less than the duty limit value, or in the case where the rotation speed becomes equal to or greater than the third threshold value (rotation speed RPM3 or greater), performs wide-angle energization control that changes the energization angle to a value exceeding 120 degrees and increases the advance angle, thereby suppressing stalling of the motor 2 while driving the motor 2 at high speed.

Further, the motor device 100 according to this embodiment, in the case where the duty ratio is equal to the duty limit value, and the rotation speed becomes less than the third threshold value (less than the rotation speed RPM3), performs control to set the energization angle to 120 degrees or less, thereby prioritizing the protection of the motor 2 by narrowing the energization angle in the case where the rotation speed does not increase despite the high duty ratio.

Furthermore, the threshold value of the rotation speed for determining whether to perform wide-angle energization control in the case where the duty ratio is equal to the duty limit value is set to the third threshold value (rotation speed RPM3) which is equal to or greater than the first threshold value (rotation speed RPM1 or greater). Accordingly, the motor device 100 according to this embodiment, in the case where the duty ratio is equal to the duty limit value, may clearly separate the region of rotation speed where control is performed to gradually increase the first upper limit value (normal duty limit value) in accordance with the increase in the rotation speed from the region of rotation speed where wide-angle energization control is performed. That is, the motor device 100 according to this embodiment may achieve both protection of the motor 2 and high-speed drive.

Further, in this embodiment, the upper limit value setting portion 44, in the change processing, changes the first upper limit value (normal duty limit value) to a second upper limit value that is a predetermined constant multiple of the first upper limit value.

Accordingly, the motor device 100 according to this embodiment, by using a simple method of a predetermined constant multiple, may avoid output limitation due to the duty ratio upper limit value even in the case where a sudden load is applied, and may increase the motor rotation speed again.

Further, by using a predetermined constant multiple, when the first upper limit value (normal duty limit value) is large, the amount of change in the duty limit value becomes large, and when the first upper limit value is small, the amount of change in the duty limit value becomes small. Thus, the motor device 100 according to this embodiment, for example, in the case where the restriction by the duty limit value is relaxed in order to actively perform stall prevention or high-speed drive of the motor 2, may output a larger duty ratio, and conversely, in the case where the motor device is somewhat passive regarding stall prevention or high-speed drive of the motor 2 and the restriction by the duty limit value is applied to some extent, the duty ratio does not increase significantly even if the change processing is performed.

Further, the motor control method according to this embodiment is a motor control method for controlling the motor 2 that is rotationally driven by an output signal output by the inverter 50 based on a drive signal and includes a drive signal generation step, a rotation speed detection step, an acceleration detection step, and an upper limit value setting step. In the drive signal generation step, the drive signal generation portion 46 controls the duty ratio indicating the drive output of the motor 2 so as not to exceed the duty limit value, and generates drive signals according to the duty ratio. In the rotation speed detection step, the rotation speed detection portion 42 detects the rotation speed of the motor 2. In the acceleration detection step, the acceleration detection portion 43 detects whether the motor 2 is accelerating or not. In the upper limit value setting step, the upper limit value setting portion 44 executes change processing to change the duty limit value to a second upper limit value (corrected duty limit value) higher than the first upper limit value (normal duty limit value) that is preset, in the case where the rotation speed of the motor 2 exceeds the rotation speed RPM1 and the motor 2 is rotating under acceleration. Further, in the upper limit value setting step, the upper limit value setting portion 44 sets the first upper limit value (normal duty limit value) to gradually increase in accordance with the increase in the rotation speed while the rotation speed is within a range from the rotation speed RPM2, that is lower than the rotation speed RPM1, to the rotation speed RPM1.

Accordingly, the control method according to this embodiment achieves the same effects as the motor device 100 described above, and may suppress stalling of the motor 2 even in the case where a load is applied from the start of the motor.

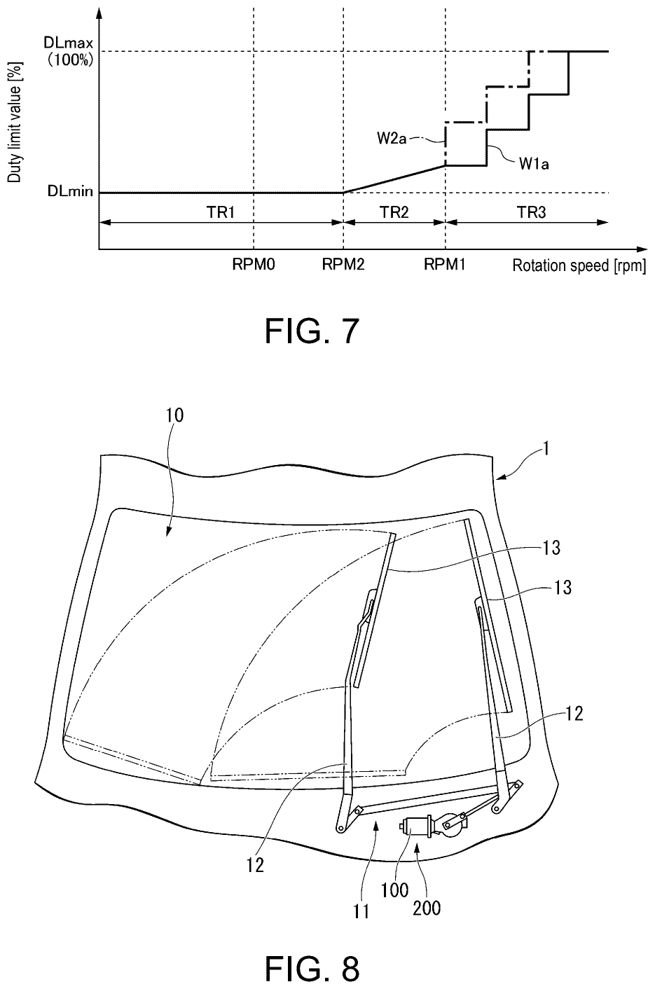

It is noted that in the motor device 100 according to this embodiment, as shown in FIG. 7, in the period TR3 exceeding the first threshold value (rotation speed RPM1), the upper limit value setting portion 44 may increase the first upper limit value (normal duty limit value) and the second upper limit value (corrected duty limit value) in a stepwise manner in accordance with the increase in the rotation speed.

FIG. 7 is a diagram illustrating a modification example of the duty limit value switching processing of the motor device 100 according to the first embodiment.

In FIG. 7, the horizontal axis of the graph represents the rotation speed [rpm] of the motor 2, and the vertical axis represents the duty limit value [%]. Further, the waveform W1a shows the waveform of the normal duty limit value, and the waveform W2a shows the waveform of the corrected duty limit value.

In the modification example shown in FIG. 7, the upper limit value setting portion 44 increases the normal duty limit value and the corrected duty limit value in a stepwise manner in the period TR3, as shown by the waveform W1a and the waveform W2a.

Next, with reference to the drawings, a wiper device 200 according to the second embodiment of the disclosure is described.

### Second Embodiment

Here, with reference to FIG. 8, an example of applying the above-described motor device 100 to a wiper device 200 is described.

FIG. 8 is a configuration diagram showing an example of the wiper device 200 according to this embodiment.

As shown in FIG. 8, the wiper device 200 performs a wiping operation on the wind surface of the window glass 10 of the vehicle 1. The wiper device 200 includes the motor device 100, a link mechanism 11, two wiper arms 12, and wiper blades 13 attached to the tip end portion of each wiper arm 12.

The motor device shown in FIG. 8 is the motor device 100 of this embodiment described above, and a detailed description thereof is omitted here. The motor device 100 includes the motor 2 and the motor control device 150.

The wiper arm 12 operates on the wind surface of the window glass 10 by the rotational drive of the motor device 100, and performs a wiping operation with the wiper blade 13 attached to the tip end portion.

The two wiper arms 12 are connected by the link mechanism 11.

The wiper blade 13 is provided to be pressed against the window glass 10 by the wiper arm 12.

The wiper blade 13 includes a blade rubber (not shown) held by a blade holder attached to the tip end portion of the wiper arm 12. When the wiper arm 12 is swung by the motor device 100, the wiper blade 13 reciprocates over the wiping range on the outer surface of the window glass 10, and wipes the window glass 10 with the blade rubber (not shown).

As described above, the wiper device 200 according to this embodiment includes the motor device 100 described above, and uses the motor device 100 to perform a wiping operation on the wind surface with the wiper member (wiper arm 12 and wiper blade 13).

Accordingly, the wiper device 200 according to this embodiment achieves the same effects as the motor device 100 described above, and may suppress stalling of the motor 2 even in the case where a load is applied from the start of the motor.

It is noted that the disclosure is not limited to the embodiments described above and may be modified within a range that does not deviate from the spirit of the disclosure.

For example, in the embodiment described above, the three-phase armature coils (21u, 21v, 21w) of the motor 2 are described as being connected by delta connection, but it is not limited thereto, and other connections such as star connection may be used.

Further, in each embodiment described above, the upper limit value setting portion 44 is described as generating and setting a corrected duty limit value from a normal duty limit value using the above-mentioned equation (1) or equation (2), but it is not limited thereto, and as shown in the following equation (3), the correction amount may be changed according to the rotation speed.

$$Corrected duty limit value = Normal duty limit value + α \times Rotation speed \qquad ( 3 )$$

Further, in each embodiment described above, the upper limit value setting portion 44 is described as increasing the normal duty limit value in direct proportion to the rotation speed during the setting change processing within a range from the rotation speed RPM2 to the rotation speed RPM1, but it is not limited thereto, and the normal duty limit value may be increased in a stepwise manner or according to a quadratic curve as the rotation speed increases.

Further, in the embodiment described above, the motor device 100 is described as used in the wiper device 200, but it is not limited thereto, and the motor device 100 may be used for other applications.

It is noted that each component included in the motor device 100 described above has a computer system internally. Then, a program for realizing the function of each configuration included in the motor device 100 described above may be recorded in a computer-readable recording medium, and the program recorded in this recording medium may be loaded into the computer system and executed so as to perform the processing in each configuration included in the motor device 100 described above. Here, “loading and executing the program recorded in the recording medium into the computer system” includes installing the program in the computer system. The “computer system” here includes hardware such as an OS and peripheral devices. In addition, the “computer system” may include a plurality of computer devices connected via a network that includes communication lines such as the Internet, WAN, LAN, and dedicated lines. Moreover, the “computer-readable recording medium” refers to a portable medium such as a flexible disk, a magneto-optical disk, a ROM, and a CD-ROM, and a storage device such as a hard disk built in the computer system. Thus, the recording medium storing the program may be a non-transitory recording medium such as a CD-ROM.

Furthermore, some or all of the functions described above may be implemented as an integrated circuit such as an LSI (large scale integration). Each of the functions mentioned above may be made into a processor individually, or some or all of the functions may be integrated and made into a processor. Also, the method of circuit integration is not limited to LSI, and may be implemented by a dedicated circuit or a general-purpose processor. In addition, when a circuit integration technology that replaces LSI becomes available because of progress in semiconductor technology, an integrated circuit based on the technology may be used.

What is claimed is:

1. A motor device, comprising:
a motor that is rotationally driven;
a drive signal generation portion, configured to control a duty ratio indicating a drive output of the motor so as not to exceed a duty ratio upper limit value and generates a drive signal in accordance with the duty ratio;
an inverter, configured to output an output signal to rotationally drive the motor based on the drive signal;
a rotation speed detection portion, configured to detect a rotation speed of the motor;
an acceleration detection portion, configured to detect whether the motor is accelerating or not; and
an upper limit value setting portion, configured to execute change processing to change the duty ratio upper limit value to a second upper limit value higher than a first upper limit value that is preset when a rotation speed of the motor exceeds a first threshold value and the motor is rotating under acceleration,
wherein the upper limit value setting portion sets the first upper limit value to gradually increase in accordance with an increase in the rotation speed while the rotation speed is within a range from a second threshold value, that is lower than the first threshold value, to the first threshold value.

2. The motor device according to claim 1, wherein the first upper limit value is set to a set minimum value, which is a constant value, when the rotation speed is less than the second threshold value, and
the upper limit value setting portion, when the motor starts, gradually increases the first upper limit value, starting from the set minimum value, in accordance with an increase in the rotation speed within a range from the second threshold value to the first threshold value.

3. The motor device according to claim 1, wherein the drive signal generation portion comprises an advance angle/energization angle controller that controls an advance angle and an energization angle of an applied voltage to the motor, and
the advance angle/energization angle controller is configured to:
change the energization angle to a value exceeding 120 degrees and increase the advance angle when the duty ratio is less than the duty ratio upper limit value, and
set the energization angle to 120 degrees or less when the duty ratio is equal to the duty ratio upper limit value and the rotation speed becomes less than a third threshold value that is set to be equal to or greater than the first threshold value.

4. The motor device according to claim 1, wherein the upper limit value setting portion changes the first upper limit value to the second upper limit value that is a predetermined constant multiple of the first upper limit value in the change processing.

5. A wiper device, comprising:
the motor device according to claim 1, and
the wiper device causing a wiper member to perform a wiping operation on a wind surface using the motor device.

6. A wiper device, comprising:
the motor device according to claim 2, and
the wiper device causing a wiper member to perform a wiping operation on a wind surface using the motor device.

7. A wiper device, comprising:
the motor device according to claim 3, and
the wiper device causing a wiper member to perform a wiping operation on a wind surface using the motor device.

8. A wiper device, comprising:
the motor device according to claim 4, and
the wiper device causing a wiper member to perform a wiping operation on a wind surface using the motor device.

9. A motor control method for controlling a motor that is rotationally driven by an output signal output by an inverter based on a drive signal, the motor control method comprising:
a drive signal generation step in which a drive signal generation portion is configured to control a duty ratio indicating a drive output of the motor so as not to exceed a duty ratio upper limit value and generates the drive signal in accordance with the duty ratio;
a rotation speed detection step in which a rotation speed detection portion is configured to detect a rotation speed of the motor;
an acceleration detection step in which an acceleration detection portion is configured to detect whether the motor is accelerating or not; and
an upper limit value setting step in which an upper limit value setting portion is configured to execute change processing to change the duty ratio upper limit value to a second upper limit value higher than a first upper limit value that is preset when a rotation speed of the motor exceeds a first threshold value and the motor is rotating under acceleration,
wherein in the upper limit value setting step, the upper limit value setting portion sets the first upper limit value to gradually increase in accordance with an increase in the rotation speed while the rotation speed is within a range from a second threshold value, that is lower than the first threshold value, to the first threshold value.
